(19) United States
(12) Patent Application Publication
(10) Pub. No.: US 2014/0366987 A1
(43) Pub. Date: Dec. 18, 2014

(54) STANDSTILL COLLECTION DEVICE FOR RESIDUAL LIQUID CRYSTAL ON WALL OF LIQUID CRYSTAL JAR

(71) Applicant: Shenzhen China Star Optoelectronics Technology Co., Ltd., Shenzhen, Guangdong (CN)

(72) Inventor: Gang Liu, Shenzhen City (CN)

(73) Assignee: Shenzhen China Star Optoelectronics Technology Co., Ltd., Shenzhen, Guangdong (CN)

(21) Appl. No.: 13/981,681

(22) PCT Filed: Jun. 21, 2013
(86) PCT No.: PCT/CN2013/077700

§ 371 Date: Jul. 25, 2013

(30) Foreign Application Priority Data
Jun. 18, 2013 (CN) 201310243036.8

(51) Int. Cl. B67D 7/84

(52) U.S. Cl. CPC B67D 7/84
USPC 141/311 R

(57) ABSTRACT

A standstill collection device for residual liquid crystal on walls of liquid crystal jars includes: a cabinet, a standing support frame mounted in the cabinet, and a collection rack mounted in the cabinet and below the standing support frame. The standing support frame receives and holds liquid crystal jars with liquid crystal residue on walls thereof. The collection rack receives and holds liquid crystal collection containers. To collect liquid crystal, the liquid crystal jars are positioned, in an inclined manner, on the standing support frame with jar openings facing downward. The liquid crystal collection containers are positioned on the collection rack with container openings facing upward. The jar openings of the liquid crystal jars are set close to the container openings of the liquid crystal collection containers and are located exactly above the container openings of the liquid crystal collection containers.

### BACKGROUND OF THE INVENTION

1. Field of the Invention

The present invention relates to a collection device, and in particular to a standstill collection device for residual liquid crystal on walls of liquid crystal jars.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise an enclosure, a liquid crystal panel arranged in the enclosure, and a backlight module that is arranged in the enclosure. The operation principle of the liquid crystal panel is that liquid crystal molecules are interposed between two parallel glass substrates and the liquid crystal molecules are controlled to rotate by the application of a driving voltage to the two glass substrates in order to refract out light emitting from the backlight module for generating images. Since the liquid crystal panel itself does not emit light, light must be provided by the backlight module in order to normally display images. Thus, the backlight module is one of the key components of an LCD. The backlight module can be classified in two types, namely side-edge backlight module and direct backlight module, according to the position where light gets incident. The direct backlight module comprises a light source, such as a cold cathode fluorescent lamp (CCFL) or a light-emitting diode (LED), which is arranged at the backside of the liquid crystal panel to form a planar light source that directly provides lighting to the liquid crystal panel. The side-edge backlight module comprises an LED light bar, serving as a backlight source, which is arranged at an edge of a backplane to be located rearward of one side of the liquid crystal panel. The LED light bar emits light that enters a light guide plate (LGP) through a light incident face of the light guide plate and is projected out of a light emergence face of the light guide plate, after being reflected and diffused, to pass through an optic film assembly to form a planar light source for the liquid crystal panel.

Referring to FIG. 1, a liquid crystal display device is generally composed of an upper substrate 100 of color filter (CF), a lower substrate 300 of thin film transistor (TFT), and liquid crystal (LC) 500, spacers 700, and sealant 900 interposed between the upper substrate 100 and the lower substrate 300. A general manufacturing process comprises a front stage of array process (including thin film, yellow light, etching, and film stripping), an intermediate stage of cell process (including bonding TFT substrate and the CF substrate), and a rear stage of module assembling process (including mounting drive ICs and printed circuit board). The front stage of array process generally makes the TFT substrate for controlling the movement of liquid crystal molecules. The intermediate stage of cell process generally introduces the liquid crystal between the TFT substrate and the CF substrate. The rear stage of assembling process generally mounts the drive ICs and combining the printed circuit board to effect driving the liquid crystal molecules to rotate for displaying images.

The conventionally used process of introducing liquid crystal between a TFT substrate and a CF substrate 200 is generally a process referred to as one drop filling (ODF), which generally comprises several steps of coating a sealant frame, filling liquid crystal, vacuum assembling, and high temperature curing, among which the step of filling liquid crystal is carried out with a distribution method or a vacuum injection method.

Liquid crystal is generally stored in a liquid crystal jar. When the liquid crystal contained in one jar is running out, residue of liquid crystal may keep sticking to an inside wall of the liquid crystal jar. Experiments that have been conducted to collect the residue of liquid crystal on the liquid crystal jar wall show that a 500 ml liquid crystal jar, when kept standing, may have a residue of liquid crystal of 3.128 g. For a 1000 ml liquid crystal jar, after set standing, may have a residue of liquid crystal of 3.794 g. Liquid crystal is a material that is of high unit price and it is one of the major concerns of the manufacturers to save the consumption of liquid crystal.

### SUMMARY OF THE INVENTION

An object of the present invention is to provide a standstill collection device for residual liquid crystal on walls of liquid crystal jars, which has a simple structure and a low cost and is effective in collecting the residual liquid crystal on the walls of the liquid crystal jars in order to cut down the manufacture cost.

To achieve the above object, the present invention provides a standstill collection device for residual liquid crystal on walls of liquid crystal jars, which comprises: a cabinet, a standing support frame mounted in the cabinet, and a collection rack mounted in the cabinet and below the standing support frame. The standing support frame receives and holds liquid crystal jars with liquid crystal residue on walls thereof. The collection rack receives and holds liquid crystal collection containers, whereby to collect liquid crystal, the liquid crystal jars with liquid crystal residue on walls thereof are positioned, in an inclined manner, on the standing support frame with jar openings facing downward. The liquid crystal collection containers are positioned on the collection rack with container openings facing upward. The jar openings of the liquid crystal jars with liquid crystal residue on walls thereof are set close to the container openings of the liquid crystal collection containers and are located exactly above the container openings of the liquid crystal collection containers.

The cabinet comprises a top board, a bottom board opposite to the top board, two side boards arranged between the top board and the bottom board and opposite to each other, a back board located between the top board and the bottom board, and a pull door arranged to be opposite to the back board.

The standing support frame comprises opposite mounting brackets, a plurality of bearing plates each having two ends respectively mounted to the mounting brackets, and a stop section having two ends respectively mounted to the mounting brackets and located below the bearing plates. The bearing plates are of a board-like structure, which comprises a plurality of semicircular recesses. The recesses have a diameter that is greater than or equal to an outside diameter of a jar body of the liquid crystal jar with liquid crystal residue on the wall thereof. The stop section comprises a plurality of stop rings respectively corresponding to the recesses. The stop rings have an inside diameter that is smaller than the outside diameter of the jar body of the liquid crystal jar with liquid crystal residue on the wall thereof but greater than an outside diameter of the jar opening of the liquid crystal jar with liquid crystal residue on the wall thereof.

The standing support frame is mounted to the two side boards in an inclined manner with a minimum included angle between an inclination direction and a vertical direction being 30°-80°, whereby the downward-facing direction of the jar openings of the liquid crystal jars with liquid crystal residue on the walls thereof positioned on the standing support frame and the vertical direction form therebetween a minimum included angle of 30°-80°.

The collection rack comprises a first rack member positioned on the bottom board and a second rack member removably mounted to the side boards. The first rack member comprises a plurality of first receiving holes formed therein to respectively correspond to the stop rings. The first receiving holes have a diameter greater than or equal to the outside diameter of the container body of the liquid crystal collection container. The second rack member comprises a plurality of second receiving holes formed therein to respectively correspond to the stop rings. The second receiving holes have a diameter that is greater than or equal to the outside diameter of the container body of the liquid crystal collection container.

Two ends of the second rack member are each provided with a slide rail. The side boards are provided with slide channels corresponding to the slide rails, whereby the slide rails are receivable in the slide channels to mount the second rack member to the side boards. The slide channels are each formed by welding two rectangular stainless steel tubes to the side boards in a spaced manner.

The top board, the bottom board, the side boards, and the back board are made of stainless steel plates having a thickness of 1.2 millimeters.

The pull door comprises door frame, door panels mounted in the door frame, and handles mounted to the door panels. The door frames and the handles are made of rectangular tubes of stainless steel. The door panels are made of a transparent material.

The mounting brackets and the stop section are made of stainless steel and the bearing plates, the first rack member, and the second rack member are made of plastics.

The cabinet has a rectangular parallelepiped configuration having a length of 654 millimeters, a width of 352 millimeters, and a height of 700 millimeters.

A standstill collection device for residual liquid crystal on walls of liquid crystal jars, which comprises: a cabinet, a standing support frame mounted in the cabinet, and a collection rack mounted in the cabinet and below the standing support frame, the standing support frame receiving and holding liquid crystal jars with liquid crystal residue on walls thereof, the collection rack receiving and holding liquid crystal collection containers, whereby to collect liquid crystal, the liquid crystal jars with liquid crystal residue on walls thereof are positioned, in an inclined manner, on the standing support frame with jar openings facing downward, the liquid crystal collection containers being positioned on the collection rack with container openings facing upward, the jar openings of the liquid crystal jars with liquid crystal residue on walls thereof being set close to the container openings of the liquid crystal collection containers and being located exactly above the container openings of the liquid crystal collection containers;

wherein the cabinet comprises a top board, a bottom board opposite to the top board, two side boards arranged between the top board and the bottom board and opposite to each other, a back board located between the top board and the bottom board, and a pull door arranged to be opposite to the back board;

wherein the standing support frame comprises opposite mounting brackets, a plurality of bearing plates each having two ends respectively mounted to the mounting brackets, and a stop section having two ends respectively mounted to the mounting brackets and located below the bearing plates, the bearing plates being of a board-like structure which comprises a plurality of semicircular recesses, the recesses having a diameter that is greater than or equal to an outside diameter of a jar body of the liquid crystal jar with liquid crystal residue on the wall thereof, the stop section comprising a plurality of stop rings respectively corresponding to the recesses, the stop rings having an inside diameter that is smaller than the outside diameter of the jar body of the liquid crystal jar with liquid crystal residue on the wall thereof but greater than an outside diameter of the jar opening of the liquid crystal jar with liquid crystal residue on the wall thereof;

wherein the standing support frame is mounted to the two side boards in an inclined manner with a minimum included angle between an inclination direction and a vertical direction being 30°-80°, whereby the downward-facing direction of the jar openings of the liquid crystal jars with liquid crystal residue on the walls thereof positioned on the standing support frame and the vertical direction form therebetween a minimum included angle of 30°-80°;

wherein the collection rack comprises a first rack member positioned on the bottom board and a second rack member removably mounted to the side boards, the first rack member comprising a plurality of first receiving holes formed therein to respectively correspond to the stop rings, the first receiving holes having a diameter greater than or equal to the outside diameter of the container body of the liquid crystal collection container, the second rack member comprising a plurality of second receiving holes formed therein to respectively correspond to the stop rings, the second receiving holes having a diameter that is greater than or equal to the outside diameter of the container body of the liquid crystal collection container;

wherein two ends of the second rack member are each provided with a slide rail, the side boards being provided with slide channels corresponding to the slide rails, whereby the slide rails are receivable in the slide channels to mount the second rack member to the side boards, the slide channels being each formed by welding two rectangular stainless steel tubes to the side boards in a spaced manner;

wherein the top board, the bottom board, the side boards, and the back board are made of stainless steel plates having a thickness of 1.2 millimeters;

wherein the pull door comprises door frame, door panels mounted in the door frame, and handles mounted to the door panels, the door frames and the handles being made of rectangular tubes of stainless steel, the door panels being made of a transparent material;

wherein the mounting brackets and the stop section are made of stainless steel and the bearing plates, the first rack member, and the second rack member are made of plastics; and

wherein the cabinet has a rectangular parallelepiped configuration having a length of 654 millimeters, a width of 352 millimeters, and a height of 700 millimeters.

The efficacy of the present invention is that the present invention provides a standstill collection device for residual liquid crystal on walls of liquid crystal jars, which allows jar openings of the liquid crystal jars with liquid crystal residue on the walls thereof to be set, in an inclined manner, above containers of liquid crystal collection containers by arranging a standing support frame and a collection rack, which is located below the standing support frame, in a cabinet and allows liquid crystal to fall from the liquid crystal jars with liquid crystal residue on the walls thereof into the liquid crystal collection containers to thereby effectively reduce the waste of liquid crystal and lower down manufacture cost. Further, the standstill collection device for residual liquid crystal on walls of liquid crystal jars has a simple structure, is easy to manufacture, has a relatively low manufacture cost, and is advantageous for cost control.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing the structure of a conventional liquid crystal display panel;

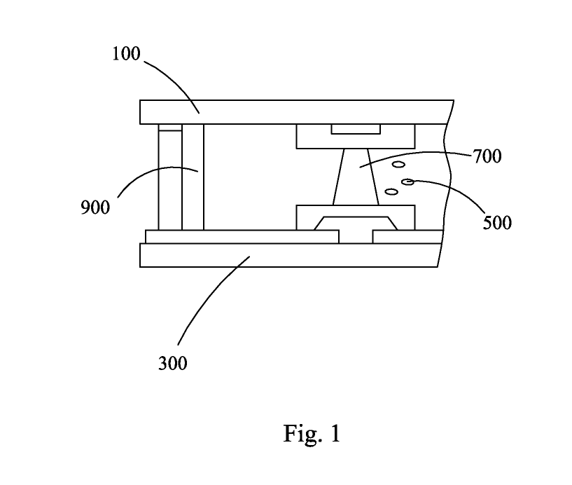

FIG. 2 is a perspective view showing a standstill collection device for residual liquid crystal on walls of liquid crystal jars;

FIG. 3 is a schematic view showing a standing support frame of the standstill collection device for residual liquid crystal on walls of liquid crystal jars according to the present invention, together with liquid crystal jars having liquid crystal residues on the walls thereof;

FIG. 4 is a front view showing the standstill collection device for residual liquid crystal on walls of liquid crystal jars according to the present invention;

FIG. 5 is a side elevational view showing the standstill collection device for residual liquid crystal on walls of liquid crystal jars according to the present invention; and

FIG. 6 is a schematic view showing another embodiment of a cabinet of the standstill collection device for residual liquid crystal on walls of liquid crystal jars according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

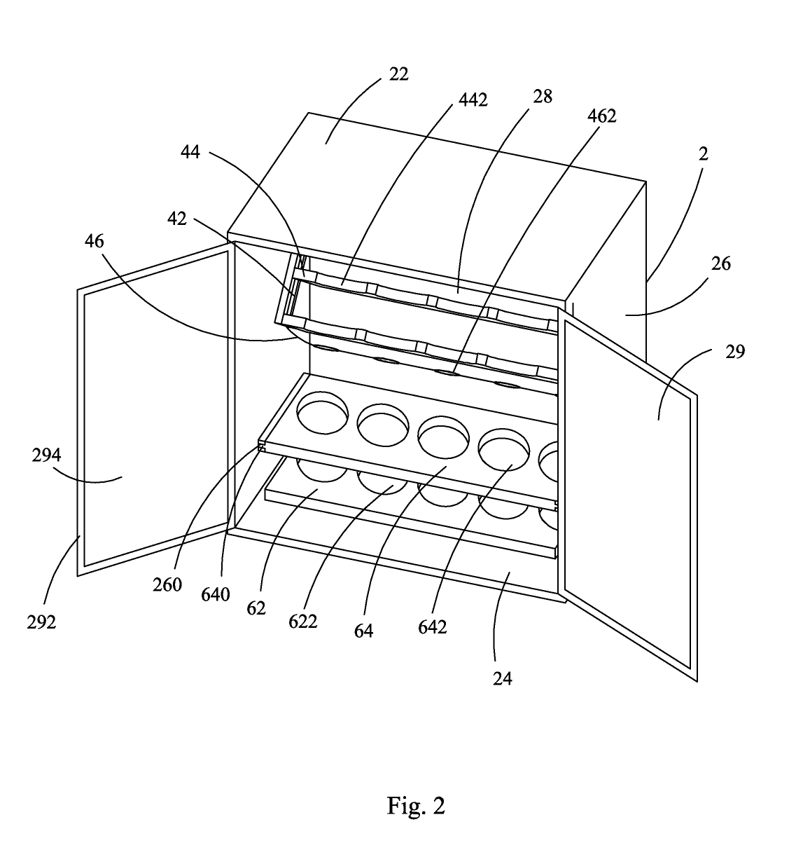

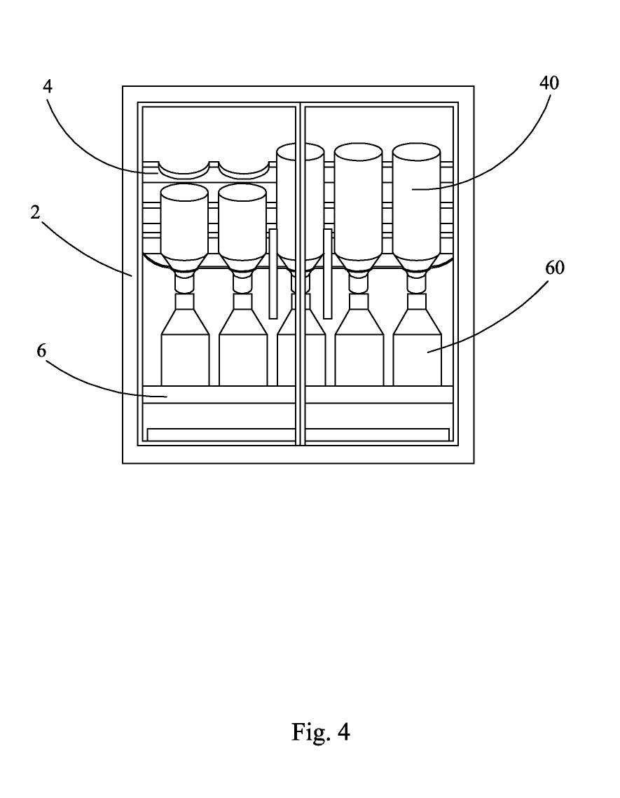

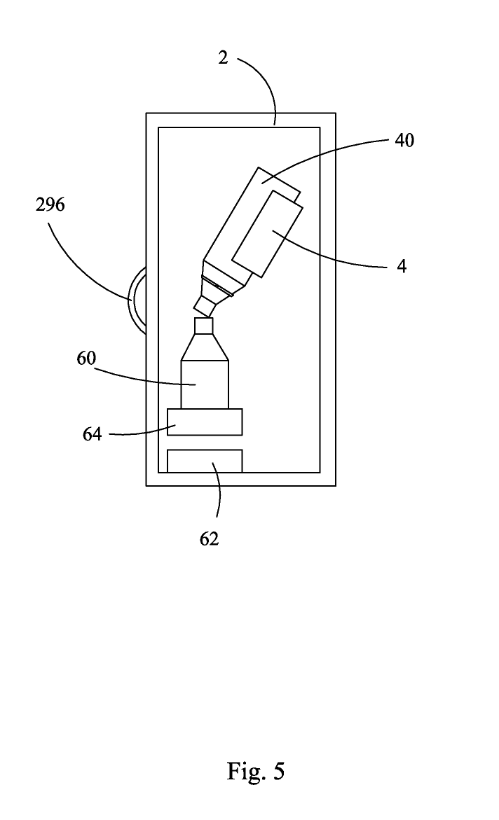

Referring to FIGS. 2-5, the present invention provides a standstill collection device for residual liquid crystal on walls of liquid crystal jars, which comprises: a cabinet 2, a standing support frame 4 mounted in the cabinet 2, and a collection rack 6 mounted in the cabinet 2 and located below the standing support frame 4. The standing support frame 4 receives and holds liquid crystal jars 40 with liquid crystal residue on the walls thereof. The collection rack 6 receives and holds liquid crystal collection containers 60. To collect liquid crystal, the liquid crystal jars 40 with liquid crystal residue on the walls thereof are positioned, in an inclined manner, on the standing support frame 4 with jar openings facing downward. The liquid crystal collection containers 60 are positioned on the collection rack 6 with container openings facing upward. The jar openings of the liquid crystal jars 40 with liquid crystal residue on the walls thereof are set close to the container openings of the liquid crystal collection containers 60 and are located exactly above the container openings of the liquid crystal collection containers 60. Due to the jar openings of the liquid crystal jars 40 with liquid crystal residue on the walls thereof being positioned in an inclined and downward-facing manner, liquid crystal that remains on the jar walls are acted upon by the gravity to move in a downward direction towards the jar openings of the liquid crystal jars 40 with liquid crystal residue on the walls thereof and eventually falls through the container openings of the liquid crystal collection containers 60 to get into the liquid crystal collection containers 60 to complete the collection of the liquid crystal.

Specifically, referring to FIG. 2, in the instant embodiment, the cabinet 2 is of a rectangular parallelepiped configuration having a length of 654 millimeters, a width of 352 millimeters, and a height of 700 millimeters. The cabinet 2 comprises a top board 22, a bottom board 24 opposite to the top board 22, two side boards 26 arranged between the top board 22 and the bottom board 24 and opposite to each other, a back board 28 located between the top board 22 and the bottom board 24, and a pull door 29 arranged to be opposite to the back board 28. The top board 22, the bottom board 24, the side boards 26, and the back board 28 are made of stainless steel boards of a thickness of 1.2 millimeters. The top board 22, the bottom board 24, the side boards 26, and the back board 28 are fixedly connected to each other through commonly used fastening solutions, such as welding and bolting, to form the rectangular parallelepiped cabinet 2, which is easy to manufacture, is durable, and has a relatively low cost.

The pull door 29 comprises door frames 292, door panels 294 respectively mounted in the door frames 292, and handles 296 respectively attached to the door panels 294. In the instant embodiment, the pull door 29 comprises two opposite panels, which can be opened and closed through operating the handles 296 in order to open and close the cabinet 2.

The door frames 292 and the handles 296 are made of rectangular tube of stainless steel, of which the specification is: 10×10×1 mm. Preferably, the door frames 292 and the handles 296 are made of SUS304. The door panels 294 are made of a transparent material, so that during the collection of liquid crystal, the door panels 294 can be closed to prevent pollution of the surrounding environment, while observation through the door panels 294 is allowed to watch the inside condition of the standstill collection device for residual liquid crystal on walls of liquid crystal jars, making the operation easy. The transparent material can be glass or clear plastics. Preferably, the door panels 294 are made of organic glass, which is not easy to break so as to extend the service life of the standstill collection device for residual liquid crystal on walls of liquid crystal jars and lower down the maintenance cost.

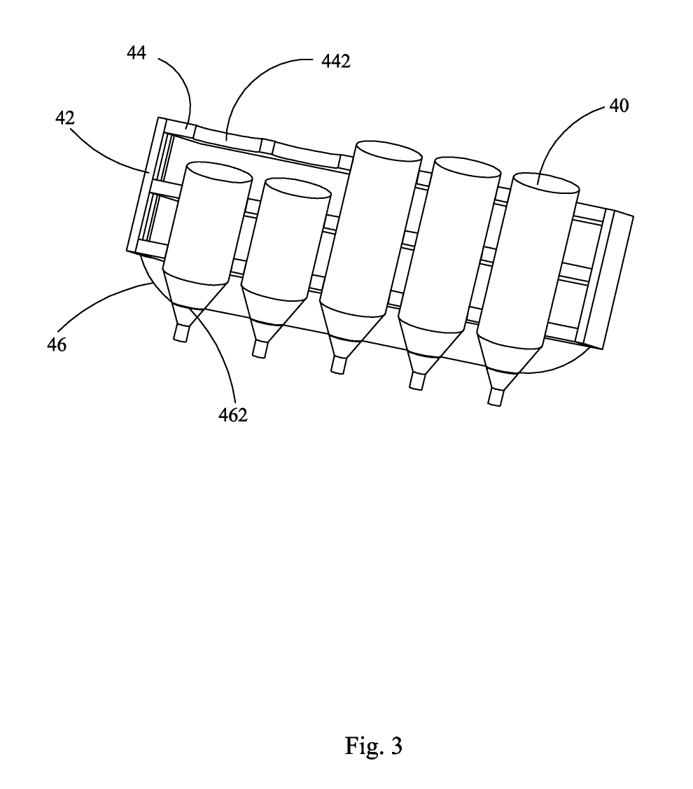

Referring to FIG. 3, the standing support frame 4 comprises opposite mounting brackets 42, a plurality of bearing plates 44 each having two ends respectively mounted to the mounting brackets 42, and a stop section 46 having two ends respectively mounted to the mounting brackets 42 and located below the bearing plates 44. The bearing plates 44 are of a board-like structure, which comprises a plurality of semicircular recesses 442. The recesses 442 have a diameter that is greater than or equal to an outside diameter of a jar body of the liquid crystal jar 40 with liquid crystal residue on the wall thereof. The stop section 46 comprises a plurality of stop rings 462 respectively corresponding to the recesses 442 and the stop rings 462 have an inside diameter that is smaller than the outside diameter of the jar body of the liquid crystal jar 40 with liquid crystal residue on the wall thereof but greater than an outside diameter of the jar opening of the liquid crystal jar 40 with liquid crystal residue on the wall thereof.

Preferably, the standing support frame 4 is mounted to the two side boards 26 in an inclined manner with a minimum included angle between an inclination direction and a vertical direction being 30°-80°, whereby the downward-facing direction of the jar openings of the liquid crystal jars 40 with liquid crystal residue on the walls thereof positioned on the standing support frame 4 and the vertical direction form therebetween a minimum included angle of 30°-80° to facilitate the residual liquid crystal inside the liquid crystal jars to smoothly flow out. The jar openings of the liquid crystal jars 40 with liquid crystal residue on the walls thereof are put, in a top-down manner, into the stop rings 462 and are retained in the stop rings 462. Under this condition, the jar bodies of the liquid crystal jars 40 with liquid crystal residue on the walls thereof are received and held in the recesses 442 of the bearing plates 44 to position the liquid crystal jars 40 with liquid crystal residue on the walls thereof. In the instant embodiment, the standing support frame 4 comprises three bearing plates 44. The three bearing plates 44 are arranged to distribute from top side to bottom side in order to keep still and collect residual liquid crystal contained in liquid crystal jars of two specifications of 500 ml and 1,000 ml. When standstill collection is conducted on the residual liquid crystal of a liquid crystal jar having a volume of 500 ml, the jar body of the 500 ml volume liquid crystal jar is positioned on the two lower ones of the bearing plates 44; and when standstill collection is conducted on the residual liquid crystal of a liquid crystal jar having a volume of 1,000 ml, the jar body of the 1,000 ml volume liquid crystal jar is positioned on the three bearing plates 44.

Specifically, in the instant embodiment, the mounting brackets 42 are made of SUS304 and are fixedly mounted to the side boards 26 through commonly used fastening means, such as welding and bolting. The bearing plates 44 are made of plastics, and are preferably integrally formed with polypropylene (PP). The bearing plates 44 can be coupled to the mounting brackets 42 through snap fitting or screwing and, in the instant embodiment, are mounted to the mounting brackets 42 through snap fitting. The snap fitting structure can be achieved with known solutions and further details are omitted herein. In the instant embodiment, the stop section 46 is made integrally of stainless steel and is mounted to the mounting brackets 42 through welding.

The collection rack 6 comprises a first rack member 62 positioned on the bottom board 24 and a second rack member 64 removably mounted to the side boards 26. The first rack member 62 comprises a plurality of first receiving holes 622 formed therein to respectively correspond to the stop rings 462. The first receiving holes 622 have a diameter greater than or equal to the outside diameter of the container body of the liquid crystal collection container 60. The second rack member 64 comprises a plurality of second receiving holes 642 formed therein to respectively correspond to the stop rings 462. The second receiving holes 642 have a diameter that is greater than or equal to the outside diameter of the container body of the liquid crystal collection container 60. The first receiving holes 622 of the first rack member 62 are provided for receiving and holding liquid crystal collection containers (not shown) having a volume of 1,000 ml volume. The second receiving holes 642 of the second rack member 64 are provided for receiving and holding liquid crystal collection containers 60 having a volume of 500 ml, whereby both 1,000 ml volume liquid crystal collection containers and 500 ml volume liquid crystal collection containers 60, when used, can be placed close to the jar openings of the liquid crystal jars 40 with liquid crystal residue on the walls thereof to ensure that the liquid crystal flowing out of the jar openings of the liquid crystal jars 40 with liquid crystal residue on the walls thereof may completely fall into the liquid crystal collection containers 60 to accomplish the collection of liquid crystal.

The first rack member 62 and the second rack member 64 are made of plastics and are preferably each made of PP as a unitary structure. Two ends of the second rack member 64 are each provided with a slide rail 640. The side boards 26 are provided with slide channels 260 corresponding to the slide rails 640, whereby the slide rails 640 are receivable in the slide channels 260 to mount the second rack member 64 to the side boards 26. In the instant embodiment, the slide channels 260 are each formed by welding two rectangular stainless steel tubes to the side boards 26 in a spaced manner, making it simple and easy and facilitating the insertion and withdrawal of the second rack member 64. When 500 ml volume liquid crystal collection containers 60 are used to collect liquid crystal, the slide rails 640 of the second rack member 64 are first inserted into the slide channels 260 of the side boards 26 and then, the liquid crystal collection containers 60 are respectively positioned in the second receiving holes 642 of the second rack member 64. Afterwards, liquid crystal jars 40 with liquid crystal residue on the walls thereof are positioned on the standing support frame 4, where the jar openings of the liquid crystal jars 40 with liquid crystal residue on the walls thereof are located exactly above the liquid crystal collection containers 60. When 1,000 ml volume liquid crystal collection containers are used to collect liquid crystal, the second rack member 64 is removed and the 1,000 volume liquid crystal collection containers are positioned in the first receiving holes 622 of the first rack member 62. Afterwards, liquid crystal jars 40 with liquid crystal residue on the walls thereof are positioned on the standing support frame 4, where the jar openings of the liquid crystal jars 40 with liquid crystal residue on the walls thereof are located exactly above the 1,000 ml volume liquid crystal collection containers.

It is noted that, to collect liquid crystal, the liquid crystal remains in the liquid crystal jars 40 with liquid crystal residue on the walls thereof is first poured into the liquid crystal collection containers 60 until there is no apparent flow of liquid crystal flowing out of the liquid crystal jars 40 with liquid crystal residue on the walls thereof. Then, the liquid crystal jars 40 with liquid crystal residue on the walls thereof are positioned on the standing support frame 4 and the liquid crystal collection containers 60 are positioned on the collection rack 6 with the liquid crystal jars 40 with liquid crystal residue on the walls thereof being kept above the liquid crystal collection containers 60 for a period of time that is greater than or equal to 15 minutes to ensure the residues of liquid crystal can be collected as much as possible and minimizing waste. During the process of collection, the pull door 29 is closed to prevent contamination of the liquid crystal by the surrounding environment. Further, the standstill collection device for residual liquid crystal on walls of liquid crystal jars can be used to collect the residual liquid crystal of multiple liquid crystal jars at the same time, making the efficiency of collection high and applicable to standstill collection of liquid crystal contained in liquid crystal jars of various specifications so as to show excellent adaptability.

Further, in a practical operation, through measurement and calculation, a stop may be provided on the bottom board 24 for positioning the first rack member 62, so that when the 1,000 ml volume liquid crystal collection containers are set on the first rack member 62, the first rack member 62 can be disposed on the bottom board 24 and positioned against the stop. When the liquid crystal jars 40 with liquid crystal residue on the walls thereof are positioned on the standing support frame 4, the container openings of the 1,000 ml volume liquid crystal collection containers are exactly under the jar openings of the liquid crystal jars 40 with liquid crystal residue on the walls thereof so that the time required for alignment can be reduced. Similarly, the second rack member 64 may be provided with a stop through measurement and calculation to achieve the same technical effect of the present invention.

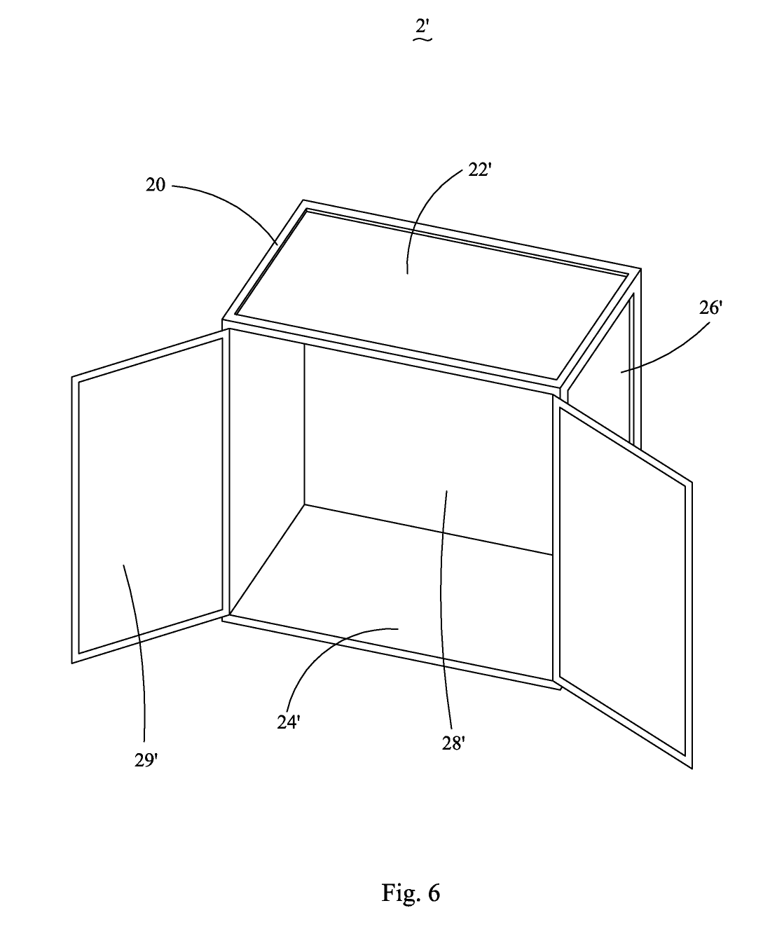

Referring to FIG. 6, which is a schematic view showing another embodiment of the cabinet of the standstill collection device for residual liquid crystal on walls of liquid crystal jars according to the present invention, in the instant embodiment, the cabinet 2′ comprises a frame 20, a top board 22′ mounted to the frame 20, a bottom board 24′ mounted to the frame 20 and opposite to the top board 22′, two side boards 26′ mounted to the frame 20 to be located between the top board 22′ and the bottom board 24′ and opposite to each other, a back board 28′ mounted to the frame 20 to be located between the top board 22′ and the bottom board 24′, and a pull door 29′ mounted to the frame 20 and arranged to be opposite to the back board 28′. The top board 22′, the bottom board 24′, the side boards 26′, and the back board 28′ are fixedly mounted to the frame 20 by welding so as to form the rectangular parallelepiped cabinet 2′. The frame 20 is made of rectangular tubes of stainless steel and preferably, the frame 20 is made of SUS304. In the instant embodiment, the rectangular tubes that make the frame 20 are of the specification: 25×25×1.2 mm. The technical effect of the present invention can be similarly achieved.

In summary, the present invention provides a standstill collection device for residual liquid crystal on walls of liquid crystal jars, which allows jar openings of the liquid crystal jars with liquid crystal residue on the walls thereof to be set, in an inclined manner, above containers of liquid crystal collection containers by arranging a standing support frame and a collection rack, which is located below the standing support frame, in a cabinet and allows liquid crystal to fall from the liquid crystal jars with liquid crystal residue on the walls thereof into the liquid crystal collection containers to thereby effectively reduce the waste of liquid crystal and lower down manufacture cost. Further, the standstill collection device for residual liquid crystal on walls of liquid crystal jars has a simple structure, is easy to manufacture, has a relatively low manufacture cost, and is advantageous for cost control.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A standstill collection device for residual liquid crystal on walls of liquid crystal jars, comprising: a cabinet (2), a standing support frame (4) mounted in the cabinet (2), and a collection rack (6) mounted in the cabinet (2) and below the standing support frame (4), the standing support frame (4) receiving and holding liquid crystal jars (40) with liquid crystal residue on walls thereof, the collection rack (6) receiving and holding liquid crystal collection containers (60), whereby to collect liquid crystal, the liquid crystal jars (40) with liquid crystal residue on walls thereof are positioned, in an inclined manner, on the standing support frame (4) with jar openings facing downward, the liquid crystal collection containers (60) being positioned on the collection rack (6) with container openings facing upward, the jar openings of the liquid crystal jars (40) with liquid crystal residue on walls thereof being set close to the container openings of the liquid crystal collection containers (60) and being located exactly above the container openings of the liquid crystal collection containers (60).

2. The standstill collection device for residual liquid crystal on walls of liquid crystal jars as claimed in claim 1, wherein the cabinet (2) comprises a top board (22), a bottom board (24) opposite to the top board (22), two side boards (26) arranged between the top board (22) and the bottom board (24) and opposite to each other, a back board (28) located between the top board (22) and the bottom board (24), and a pull door (29) arranged to be opposite to the back board (28).

3. The standstill collection device for residual liquid crystal on walls of liquid crystal jars as claimed in claim 2, wherein the standing support frame (4) comprises opposite mounting brackets (42), a plurality of bearing plates (44) each having two ends respectively mounted to the mounting brackets (42), and a stop section (46) having two ends respectively mounted to the mounting brackets (42) and located below the bearing plates (44), the bearing plates (44) being of a board-like structure which comprises a plurality of semicircular recesses (442), the recesses (442) having a diameter that is greater than or equal to an outside diameter of a jar body of the liquid crystal jar (40) with liquid crystal residue on the wall thereof, the stop section (46) comprising a plurality of stop rings (462) respectively corresponding to the recesses (442), the stop rings (462) having an inside diameter that is smaller than the outside diameter of the jar body of the liquid crystal jar (40) with liquid crystal residue on the wall thereof but greater than an outside diameter of the jar opening of the liquid crystal jar (40) with liquid crystal residue on the wall thereof.

4. The standstill collection device for residual liquid crystal on walls of liquid crystal jars as claimed in claim 3, wherein the standing support frame (4) is mounted to the two side boards (26) in an inclined manner with a minimum included angle between an inclination direction and a vertical direction being 30°-80°, whereby the downward-facing direction of the jar openings of the liquid crystal jars (40) with liquid crystal residue on the walls thereof positioned on the standing support frame (4) and the vertical direction form therebetween a minimum included angle of 30°-80°.

5. The standstill collection device for residual liquid crystal on walls of liquid crystal jars as claimed in claim 3, wherein the collection rack (6) comprises a first rack member (62) positioned on the bottom board (24) and a second rack member (64) removably mounted to the side boards (26), the first rack member (62) comprising a plurality of first receiving holes (622) formed therein to respectively correspond to the stop rings (462), the first receiving holes (622) having a diameter greater than or equal to the outside diameter of the container body of the liquid crystal collection container (60), the second rack member (64) comprising a plurality of second receiving holes (642) formed therein to respectively correspond to the stop rings (462), the second receiving holes (642) having a diameter that is greater than or equal to the outside diameter of the container body of the liquid crystal collection container (60).

6. The standstill collection device for residual liquid crystal on walls of liquid crystal jars as claimed in claim 5, wherein two ends of the second rack member (64) are each provided with a slide rail (640), the side boards (26) being provided with slide channels (260) corresponding to the slide rails (640), whereby the slide rails (640) are receivable in the slide channels (260) to mount the second rack member (64) to the side boards (26), the slide channels (260) being each formed by welding two rectangular stainless steel tubes to the side boards (26) in a spaced manner.

7. The standstill collection device for residual liquid crystal on walls of liquid crystal jars as claimed in claim 2, wherein the top board (22), the bottom board (24), the side boards (26), and the back board (28) are made of stainless steel plates having a thickness of 1.2 millimeters.

8. The standstill collection device for residual liquid crystal on walls of liquid crystal jars as claimed in claim 2, wherein the pull door (29) comprises door frame (292), door panels (294) mounted in the door frame (292), and handles (296) mounted to the door panels (294), the door frames (292) and the handles (296) being made of rectangular tubes of stainless steel, the door panels (294) being made of a transparent material.

9. The standstill collection device for residual liquid crystal on walls of liquid crystal jars as claimed in claim 4, wherein the mounting brackets (42) and the stop section (46) are made of stainless steel and the bearing plates (44), the first rack member (62), and the second rack member (64) are made of plastics.

10. The standstill collection device for residual liquid crystal on walls of liquid crystal jars as claimed in claim 1, wherein the cabinet (2) has a rectangular parallelepiped configuration having a length of 654 millimeters, a width of 352 millimeters, and a height of 700 millimeters.

11. A standstill collection device for residual liquid crystal on walls of liquid crystal jars, comprising: a cabinet (2), a standing support frame (4) mounted in the cabinet (2), and a collection rack (6) mounted in the cabinet (2) and below the standing support frame (4), the standing support frame (4) receiving and holding liquid crystal jars (40) with liquid crystal residue on walls thereof, the collection rack (6) receiving and holding liquid crystal collection containers (60), whereby to collect liquid crystal, the liquid crystal jars (40) with liquid crystal residue on walls thereof are positioned, in an inclined manner, on the standing support frame (4) with jar openings facing downward, the liquid crystal collection containers (60) being positioned on the collection rack (6) with container openings facing upward, the jar openings of the liquid crystal jars (40) with liquid crystal residue on walls thereof being set close to the container openings of the liquid crystal collection containers (60) and being located exactly above the container openings of the liquid crystal collection containers (60);
wherein the cabinet (2) comprises a top board (22), a bottom board (24) opposite to the top board (22), two side boards (26) arranged between the top board (22) and the bottom board (24) and opposite to each other, a back board (28) located between the top board (22) and the bottom board (24), and a pull door (29) arranged to be opposite to the back board (28);
wherein the standing support frame (4) comprises opposite mounting brackets (42), a plurality of bearing plates (44) each having two ends respectively mounted to the mounting brackets (42), and a stop section (46) having two ends respectively mounted to the mounting brackets (42) and located below the bearing plates (44), the bearing plates (44) being of a board-like structure which comprises a plurality of semicircular recesses (442), the recesses (442) having a diameter that is greater than or equal to an outside diameter of a jar body of the liquid crystal jar (40) with liquid crystal residue on the wall thereof, the stop section (46) comprising a plurality of stop rings (462) respectively corresponding to the recesses (442), the stop rings (462) having an inside diameter that is smaller than the outside diameter of the jar body of the liquid crystal jar (40) with liquid crystal residue on the wall thereof but greater than an outside diameter of the jar opening of the liquid crystal jar (40) with liquid crystal residue on the wall thereof;
wherein the standing support frame (4) is mounted to the two side boards (26) in an inclined manner with a minimum included angle between an inclination direction and a vertical direction being 30°-80°, whereby the downward-facing direction of the jar openings of the liquid crystal jars (40) with liquid crystal residue on the walls thereof positioned on the standing support frame (4) and the vertical direction form therebetween a minimum included angle of 30°-80°;
wherein the collection rack (6) comprises a first rack member (62) positioned on the bottom board (24) and a second rack member (64) removably mounted to the side boards (26), the first rack member (62) comprising a plurality of first receiving holes (622) formed therein to respectively correspond to the stop rings (462), the first receiving holes (622) having a diameter greater than or equal to the outside diameter of the container body of the liquid crystal collection container (60), the second rack member (64) comprising a plurality of second receiving holes (642) formed therein to respectively correspond to the stop rings (462), the second receiving holes (642) having a diameter that is greater than or equal to the outside diameter of the container body of the liquid crystal collection container (60);
wherein two ends of the second rack member (64) are each provided with a slide rail (640), the side boards (26) being provided with slide channels (260) corresponding to the slide rails (640), whereby the slide rails (640) are receivable in the slide channels (260) to mount the second rack member (64) to the side boards (26), the slide channels (260) being each formed by welding two rectangular stainless steel tubes to the side boards (26) in a spaced manner;
wherein the top board (22), the bottom board (24), the side boards (26), and the back board (28) are made of stainless steel plates having a thickness of 1.2 millimeters;
wherein the pull door (29) comprises door frame (292), door panels (294) mounted in the door frame (292), and handles (296) mounted to the door panels (294), the door frames (292) and the handles (296) being made of rectangular tubes of stainless steel, the door panels (294) being made of a transparent material;
wherein the mounting brackets (42) and the stop section (46) are made of stainless steel and the bearing plates (44), the first rack member (62), and the second rack member (64) are made of plastics; and
wherein the cabinet (2) has a rectangular parallelepiped configuration having a length of 654 millimeters, a width of 352 millimeters, and a height of 700 millimeters.
